(19) United States
(12) Patent Application Publication
(10) Pub. No.: US 2017/0013433 A1
(43) Pub. Date: Jan. 12, 2017

(54) METHOD AND APPARATUS FOR TRANSMITTING MULTIMEDIA BROADCAST SUPPLEMENT FOR PUBLIC WARNING SYSTEM IN WIRELESS COMMUNICATION SYSTEM

(71) Applicant: LG ELECTRONICS INC., Seoul (KR)

(72) Inventors: Youngdae LEE, Seoul (KR); Sangwon KIM, Seoul (KR); Sunghoon JUNG, Seoul (KR)

(21) Appl. No.: 15/115,871

(22) PCT Filed: Mar. 11, 2015
(86) PCT No.: PCT/KR2015/002368

§ 371 Date: Aug. 1, 2016

Related U.S. Application Data
(60) Provisional application No. 61/952,148, filed on Mar. 13, 2014.

(51) Int. Cl. H04W 4/22; H04W 4/06; H04W 68/02; H04W 72/00; H04L 12/18; H04W 72/04

(52) U.S. Cl. CPC H04W 4/22; H04L 12/189; H04W 72/042; H04W 68/02; H04W 72/005; H04W 4/06

(57) ABSTRACT

A method and apparatus for acquiring multimedia broadcast supplement (MBS) for a public warning system (PWS) in a wireless communication system is provided. A user equipment (UE) receives MBS information, which indicates a cell supports the MBS for the PWS, from a network. The UE further receives a MBS indication for the PWS from the network. The UE acquires the MBS for the PWS via a broadcast/multicast channel from the network.

### BACKGROUND OF THE INVENTION

Field of the Invention

The present invention relates to wireless communications, and more particularly, to a method and apparatus for transmitting multimedia broadcast supplement (MBS) for a public warning system (PWS) in a wireless communication system.

Related Art

Universal mobile telecommunications system (UMTS) is a 3rd generation (3G) asynchronous mobile communication system operating in wideband code division multiple access (WCDMA) based on European systems, global system for mobile communications (GSM) and general packet radio services (GPRS). A long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

The 3GPP LTE can provide a multimedia broadcast multicast service (MBMS) service. The MBMS is a service which simultaneously transmits data packets to multiple users. If a specific level of users exists in the same cell, the respective users can be allowed to share necessary resources so that the plurality of users can receive the same multimedia data, thereby increasing resource efficiency. In addition, a multimedia service can be used with a low cost from the perspective of users.

Recently, there has been an interest to ensure that the public has the capability to receive timely and accurate alerts, warnings and critical information regarding disasters and other emergencies irrespective of what communications technologies they use. As has been learned from disasters such as earthquakes, tsunamis, hurricanes and wild fires, such a capability is essential to enable the public to take appropriate action to protect their families and themselves from serious injury, or loss of life or property. This interest to enhance the reliability, resiliency, and security of warning notifications to the public by providing a mechanism to distribute warning notifications over 3GPP systems is the impetus for a public warning system (PWS).

Transmission of additional information for the PWS via MBMS has been discussed. The additional information transmitted via MBMS may be referred to as multimedia broadcast supplement (MBS). For example, such as sounds, photos, videos, etc., for the PWS may be transmitted for the MBS. An efficient method for transmitting the MBS for the PWS may be required.

### SUMMARY OF THE INVENTION

The present invention provides a method and apparatus for transmitting multimedia broadcast supplement (MBS) for a public warning system (PWS) in a wireless communication system. The present invention provides a method for transmitting a MBS indication for the PWS.

In an aspect, a method for acquiring, by a user equipment (UE), multimedia broadcast supplement (MBS) for a public warning system (PWS) in a wireless communication system is provided. The method includes receiving, by the UE, MBS information from a network, receiving, by the UE, a MBS indication for the PWS from the network, and acquiring, by the UE, the MBS for the PWS via a broadcast/multicast channel from the network.

In another aspect, a user equipment (UE) configured to acquire multimedia broadcast supplement (MBS) for a public warning system (PWS) in a wireless communication system is provided. The UE includes a radio frequency (RF) unit configured to transmit or receive a radio signal, and a processor coupled to the RF unit, and configured to receive MBS information from a network, receive a MBS indication for the PWS from the network, and acquire the MBS for the PWS via a broadcast/multicast channel from the network.

The MBS for the PWS can be provided quickly.

### BRIEF DESCRIPTION OF THE DRAWINGS

FIG. 1 shows LTE system architecture.

FIG. 2 shows a block diagram of architecture of a typical E-UTRAN and a typical EPC.

FIG. 3 shows a block diagram of a user plane protocol stack of an LTE system.

FIG. 4 shows a block diagram of a control plane protocol stack of an LTE system.

FIG. 5 shows an example of a physical channel structure.

FIG. 6 shows a system information acquisition procedure.

FIG. 7 shows a paging procedure.

FIG. 8 shows MBMS definitions.

FIG. 9 shows a MCCH information acquisition procedure.

FIG. 10 shows an example of a method for transmitting MBS for PWS according to an embodiment of the present invention.

FIG. 11 shows another example of a method for transmitting MBS for PWS according to an embodiment of the present invention.

FIG. 12 shows a wireless communication system to implement an embodiment of the present invention.

### DESCRIPTION OF EXEMPLARY EMBODIMENTS

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink. LTE-advance (LTE-A) is an evolution of the 3GPP LTE.

For clarity, the following description will focus on the LTE-A. However, technical features of the present invention are not limited thereto.

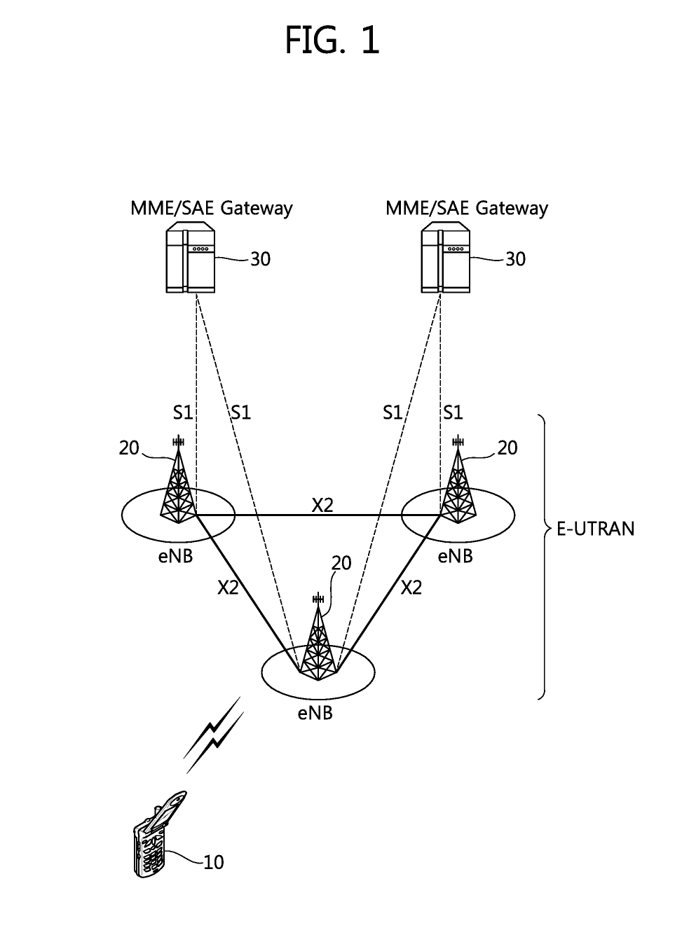

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), an access point, etc. One eNB 20 may be deployed per cell.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) and a system architecture evolution (SAE) gateway (S-GW). The MME/S-GW 30 may be positioned at the end of the network and connected to an external network. For clarity, MME/S-GW 30 will be referred to herein simply as a “gateway,” but it is understood that this entity includes both the MME and S-GW.

The MME provides various functions including non-access stratum (NAS) signaling to eNBs 20, NAS signaling security, access stratum (AS) security control, inter core network (CN) node signaling for mobility between 3GPP access networks, idle mode UE reachability (including control and execution of paging retransmission), tracking area list management (for UE in idle and active mode), packet data network (PDN) gateway (P-GW) and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on access point name aggregate maximum bit rate (APN-AMBR).

Interfaces for transmitting user traffic or control traffic may be used. The UE 10 is connected to the eNB 20 via a Uu interface. The eNBs 20 are connected to each other via an X2 interface. Neighboring eNBs may have a meshed network structure that has the X2 interface. A plurality of nodes may be connected between the eNB 20 and the gateway 30 via an S1 interface.

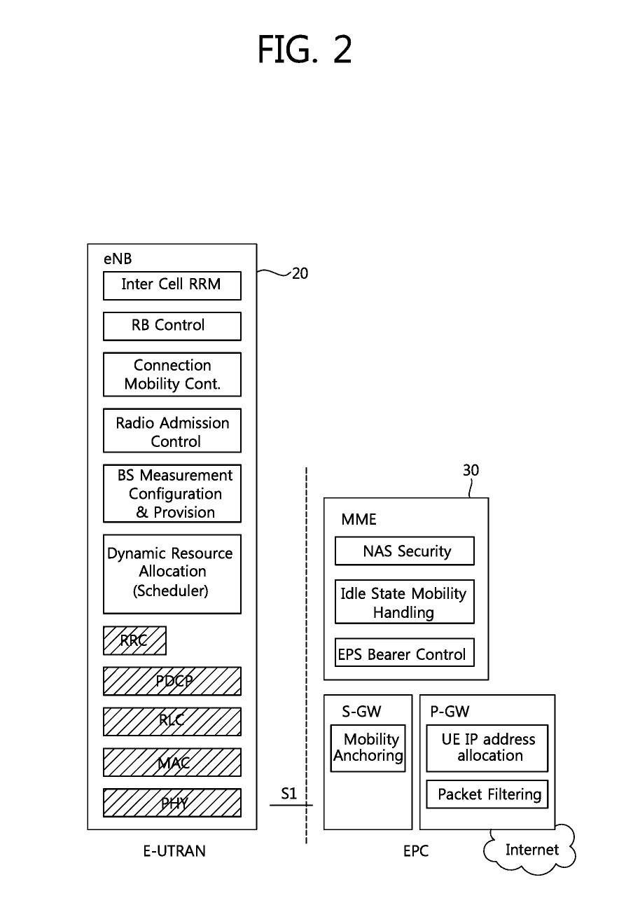

FIG. 2 shows a block diagram of architecture of a typical E-UTRAN and a typical EPC. Referring to FIG. 2, the eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE_ACTIVE state. In the EPC, and as noted above, gateway 30 may perform functions of paging origination, LTE_IDLE state management, ciphering of the user plane, SAE bearer control, and ciphering and integrity protection of NAS signaling.

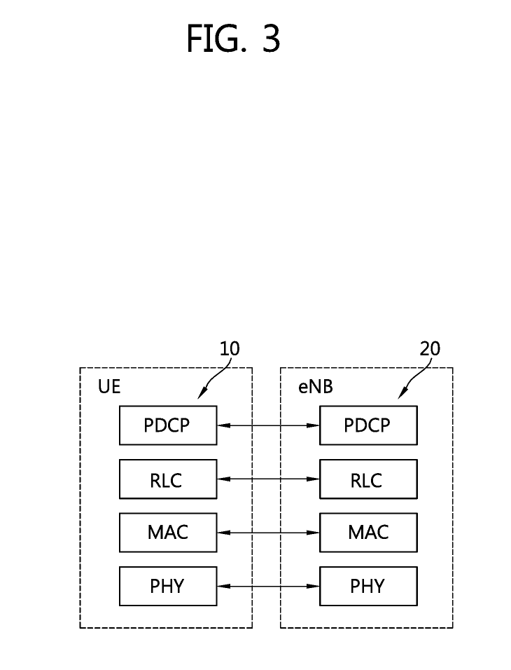

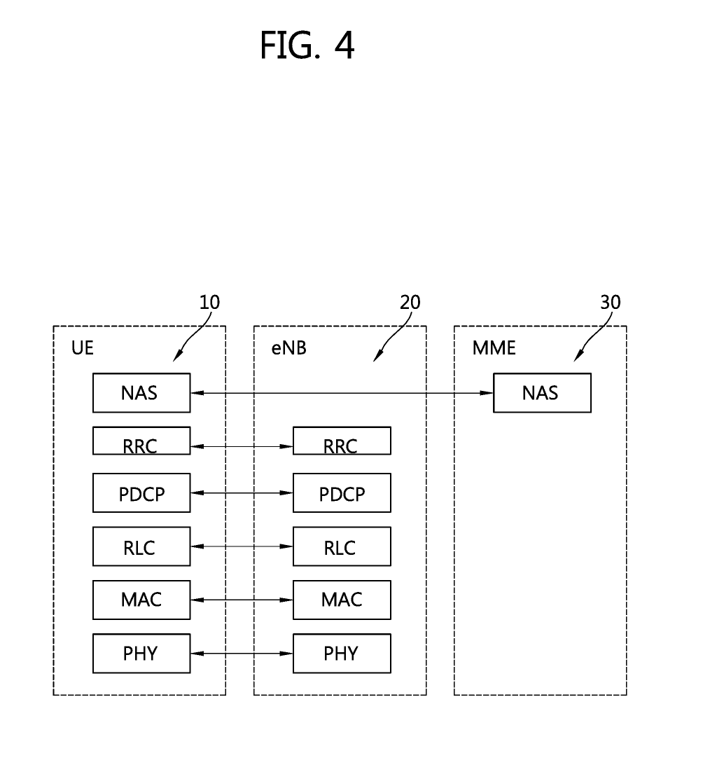

FIG. 3 shows a block diagram of a user plane protocol stack of an LTE system. FIG. 4 shows a block diagram of a control plane protocol stack of an LTE system. Layers of a radio interface protocol between the UE and the E-UTRAN may be classified into a first layer (L1), a second layer (L2), and a third layer (L3) based on the lower three layers of the open system interconnection (OSI) model that is well-known in the communication system.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data between the MAC layer and the PHY layer is transferred through the transport channel. Between different PHY layers, i.e. between a PHY layer of a transmission side and a PHY layer of a reception side, data is transferred via the physical channel.

A MAC layer, a radio link control (RLC) layer, and a packet data convergence protocol (PDCP) layer belong to the L2. The MAC layer provides services to the RLC layer, which is a higher layer of the MAC layer, via a logical channel. The MAC layer provides data transfer services on logical channels. The RLC layer supports the transmission of data with reliability. Meanwhile, a function of the RLC layer may be implemented with a functional block inside the MAC layer. In this case, the RLC layer may not exist. The PDCP layer provides a function of header compression function that reduces unnecessary control information such that data being transmitted by employing IP packets, such as IPv4 or IPv6, can be efficiently transmitted over a radio interface that has a relatively small bandwidth.

A radio resource control (RRC) layer belongs to the L3. The RLC layer is located at the lowest portion of the L3, and is only defined in the control plane. The RRC layer controls logical channels, transport channels, and physical channels in relation to the configuration, reconfiguration, and release of radio bearers (RBs). The RB signifies a service provided the L2 for data transmission between the UE and E-UTRAN.

Referring to FIG. 3, the RLC and MAC layers (terminated in the eNB on the network side) may perform functions such as scheduling, automatic repeat request (ARQ), and hybrid ARQ (HARQ). The PDCP layer (terminated in the eNB on the network side) may perform the user plane functions such as header compression, integrity protection, and ciphering.

Referring to FIG. 4, the RLC and MAC layers (terminated in the eNB on the network side) may perform the same functions for the control plane. The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

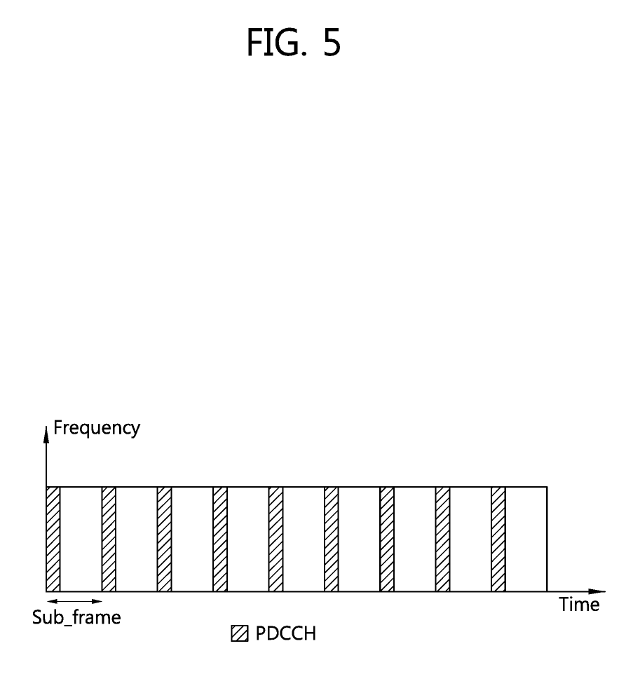

FIG. 5 shows an example of a physical channel structure. A physical channel transfers signaling and data between PHY layer of the UE and eNB with a radio resource. A physical channel consists of a plurality of subframes in time domain and a plurality of subcarriers in frequency domain. One subframe, which is 1 ms, consists of a plurality of symbols in the time domain. Specific symbol(s) of the subframe, such as the first symbol of the subframe, may be used for a physical downlink control channel (PDCCH). The PDCCH carries dynamic allocated resources, such as a physical resource block (PRB) and modulation and coding scheme (MCS).

A DL transport channel includes a broadcast channel (BCH) used for transmitting system information, a paging channel (PCH) used for paging a UE, a downlink shared channel (DL-SCH) used for transmitting user traffic or control signals, a multicast channel (MCH) used for multicast or broadcast service transmission. The DL-SCH supports HARQ, dynamic link adaptation by varying the modulation, coding and transmit power, and both dynamic and semi-static resource allocation. The DL-SCH also may enable broadcast in the entire cell and the use of beamforming.

A UL transport channel includes a random access channel (RACH) normally used for initial access to a cell, a uplink shared channel (UL-SCH) for transmitting user traffic or control signals, etc. The UL-SCH supports HARQ and dynamic link adaptation by varying the transmit power and potentially modulation and coding. The UL-SCH also may enable the use of beamforming.

The logical channels are classified into control channels for transferring control plane information and traffic channels for transferring user plane information, according to a type of transmitted information. That is, a set of logical channel types is defined for different data transfer services offered by the MAC layer.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting multimedia broadcast multicast services (MBMS) control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RRC state indicates whether an RRC layer of the UE is logically connected to an RRC layer of the E-UTRAN. The RRC state may be divided into two different states such as an RRC idle state (RRC_IDLE) and an RRC connected state (RRC_CONNECTED). In RRC_IDLE, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE, no RRC context is stored in the eNB.

In RRC_CONNECTED, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion. A paging message is transmitted over all cells belonging to the same tracking area. If the UE moves from one tracking area (TA) to another TA, the UE will send a tracking area update (TAU) message to the network to update its location.

A public warning system (PWS) is described. The E-UTRAN provides support for warning systems through means of system information broadcast capability. The E-UTRAN performs scheduling and broadcasting of the “warning message content” received from the cell broadcast center (CBC), which is forwarded to the E-UTRAN by the MME. The schedule information for the broadcast is received along with the “warning message content” from the CBC. The E-UTRAN is also responsible for paging the UE to provide indication that the warning notification is being broadcast. The “warning message content” received by the E-UTRAN contains an instance of the warning notification. Depending on the size, the E-UTRAN may segment the secondary notification before sending it over the radio interface.

In addition to the PWS message transmitted via system information, additional information for the PWS may be further transmitted. Use cases and scenarios of the additional information for the PWS are described below. In the description below, for pre-conditions, the mobile network operator (MNO) network supports PWS, and the MNO supports a mechanism for wide distribution of multimedia content to a large population without overloading the network (e.g. via broadcast).

1. Geo-Targeted Warning

This use case describes a user within a PWS-enabled network receiving a PWS message enhanced with geographical data in the form of a map overlay. For example, a flood occurs and is monitored by the meteorological service. Due to the severity, the decision is made to notify all users within the potential reach of the flood waters. This area is significantly larger than the currently affected area due to geography of the area. A public service announcement is created whereby the current reach of the flood waters and the projected reach of the flood waters are plotted onto a map overlay. A PWS message is sent out to users within a notification area defined by the emergency services. As part of the PWS message, the map overlay may be presented to the user. Accordingly, all users within the notification area receive the PWS message warning them about the abduction. Users who chose to view the map overlay are given extra information about the current and future flood area. Users who are notified by PWS that there is a flood but who can see from the map that they are in no immediate or projected danger can be more assured of their safety and gauge their preparations accordingly.

2. Multimedia Download

This use case describes a user within a PWS-enabled network receiving a PWS notification supplemented by a separate transmission of multimedia content in the form of downloaded multimedia.

For example, a child has been abducted and the emergency services have been informed. The emergency services have decided that due to information gathered, it may be useful to inform users in an area of this abduction and to enable local residents to be vigilant. An announcement is created whereby details of the abductee (photo, age, height, video, context etc.) are packaged together. A PWS notification is sent out to users within a notification area defined by the emergency services. As part of the PWS notification, the multimedia package may be presented to the user. Accordingly, all users within the notification area receive the PWS notification warning them about the abduction. Users who chose to view the multimedia content are given extra information about the abductee and context, and are able to be additionally vigilant for the abductee.

For another example, an earthquake has occurred some time ago. Communication services are limited and patchy. As part of the response to the disaster, a list of missing persons has been compiled. An announcement is created whereby details of the missing people (photo, age, height, video, context etc.) are packaged together. This package is then broadcast in an object carousel. As the details of the missing people changes, this package is modified on the server. A PWS notification is sent out to users within a notification area defined by the emergency services or missing persons bureau. As part of the PWS notification, there is information to enable the UE to download the latest information package on missing persons from the broadcast. The UE downloads the content from the broadcast and the user views the initial package of missing people's data. At a later date (before the end of the broadcast), the UE is notified that the contents of the carousel have changed, and the UE downloads the content from the broadcast and the user views an updated version of the missing people's data. Accordingly, all users within the notification area receive the PWS notification informing them about the missing people. Users who chose to view the multimedia content are given extra information about the missing persons and are able to assist in the recovery effort more effectively.

System information regarding the PWS is described. It may be referred to Section 5.2 of 3GPP TS 36.331 V12.0.0 (2013-12). System information is divided into the MasterInformationBlock (MIB) and a number of SystemInformationBlocks (SIBs). The MIB includes a limited number of most essential and most frequently transmitted parameters that are needed to acquire other information from the cell, and is transmitted on BCH. SIBs other than SystemInformationBlockType1 are carried in SystemInformation (SI) messages and mapping of SIBs to SI messages is flexibly configurable by schedulingInfoList included in SystemInformationBlockType1. Each SIB is contained only in a single SI message, only SIBs having the same scheduling requirement (periodicity) can be mapped to the same SI message, and SystemInformationBlockType2 is always mapped to the SI message that corresponds to the first entry in the list of SI messages in schedulingInfoList. There may be multiple SI messages transmitted with the same periodicity. SystemInformationBlockType1 and all SI messages are transmitted on DL-SCH.

In addition to broadcasting, the E-UTRAN may provide SystemInformationBlockType1, including the same parameter values, via dedicated signaling i.e., within an RRCConnectionReconfiguration message.

The UE applies the system information acquisition and change monitoring procedures for the primary cell (PCell). For a secondary cell (SCell), the E-UTRAN provides, via dedicated signaling, all system information relevant for operation in RRC_CONNECTED when adding the SCell. Upon change of the relevant system information of a configured SCell, the E-UTRAN releases and subsequently adds the concerned SCell, which may be done with a single RRCConnectionReconfiguration message. If the UE is receiving or interested to receive an MBMS service in a cell, the UE shall apply the system information acquisition and change monitoring procedure relevant for MBMS operation for this cell. The E-UTRAN may configure via dedicated signaling different parameter values than the ones broadcast in the concerned SCell.

A relay node (RN) configured with an RN subframe configuration does not need to apply the system information acquisition and change monitoring procedures. Upon change of any system information relevant to an RN, the E-UTRAN provides the system information blocks containing the relevant system information to an RN configured with an RN subframe configuration via dedicated signaling using the RNReconfiguration message. For RNs configured with an RN subframe configuration, the system information contained in this dedicated signaling replaces any corresponding stored system information and takes precedence over any corresponding system information acquired through the system information acquisition procedure. The dedicated system information remains valid until overridden. The E-UTRAN may configure an RN, via dedicated signaling, with different parameter values than the ones broadcast in the concerned cell.

Earthquake and tsunami warning service (ETWS) primary notification and/or ETWS secondary notification can occur at any point in time. The Paging message is used to inform ETWS capable UEs in RRC_IDLE and UEs in RRC_CONNECTED about presence of an ETWS primary notification and/or ETWS secondary notification. If the UE receives the Paging message including the etws-Indication, it shall start receiving the ETWS primary notification and/or ETWS secondary notification according to schedulingInfoList contained in SystemInformationBlockType1. If the UE receives the Paging message including the etws-Indication while it is acquiring ETWS notification(s), the UE shall continue acquiring ETWS notification(s) based on the previously acquired schedulingInfoList until it re-acquires schedulingInfoList in SystemInformationBlockType1. The UE is not required to periodically check schedulingInfoList contained in SystemInformationBlockType1, but the Paging message including the etws-Indication triggers the UE to re-acquire schedulingInfoList contained in SystemInformationBlockType1 for scheduling changes for SystemInformationBlockType10 and SystemInformationBlockType11. The UE may or may not receive the Paging message including the etws-Indication and/or systeminfoModification when ETWS is no longer scheduled. ETWS primary notification is contained in SystemInformationBlockType10 and ETWS secondary notification is contained in SystemInformationBlockType11. Segmentation can be applied for the delivery of a secondary notification. The segmentation is fixed for transmission of a given secondary notification within a cell (i.e. the same segment size for a given segment with the same messageIdentifier, serialNumber and warningMessageSegmentNumber). An ETWS secondary notification corresponds to a single CB data IE.

Commercial mobile alert system (CMAS) notification can occur at any point in time. The Paging message is used to inform CMAS capable UEs in RRC_IDLE and UEs in RRC_CONNECTED about presence of one or more CMAS notifications. If the UE receives the Paging message including the cmas-Indication, it shall start receiving the CMAS notifications according to schedulingInfoList contained in SystemInformationBlockType1. If the UE receives the Paging message including the cmas-Indication while it is acquiring CMAS notification(s), the UE shall continue acquiring CMAS notification(s) based on the previously acquired schedulingInfoList until it re-acquires schedulingInfoList in SystemInformationBlockType1. The UE is not required to periodically check schedulingInfoList contained in SystemInformationBlockType1, but the Paging message including the cmas-Indication triggers the UE to re-acquire schedulingInfoList contained in SystemInformationBlockType1 for scheduling changes for SystemInformationBlockType12. The UE may or may not receive the Paging message including the cmas-Indication and/or systeminfoModification when SystemInformationBlockType12 is no longer scheduled.

CMAS notification is contained in SystemInformationBlockType12. Segmentation can be applied for the delivery of a CMAS notification. The segmentation is fixed for transmission of a given CMAS notification within a cell (i.e. the same segment size for a given segment with the same messageIdentifier, serialNumber and warningMessageSegmentNumber). The E-UTRAN does not interleave transmissions of CMAS notifications, i.e. all segments of a given CMAS notification transmission are transmitted prior to those of another CMAS notification. A CMAS notification corresponds to a single CB data IE.

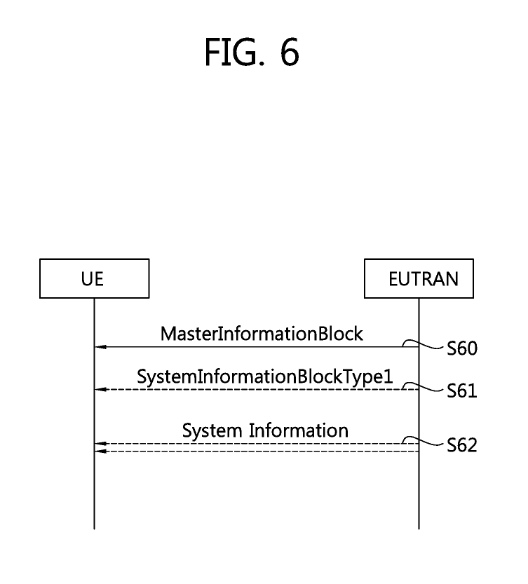

FIG. 6 shows a system information acquisition procedure. The UE applies the system information acquisition procedure to acquire the AS- and NAS-system information that is broadcasted by the E-UTRAN. The procedure applies to UEs in RRC_IDLE and UEs in RRC_CONNECTED. The UE shall apply the system information acquisition procedure upon selecting (e.g. upon power on) and upon re-selecting a cell, after handover completion, after entering E-UTRA from another RAT, upon return from out of coverage, upon receiving a notification that the system information has changed, upon receiving an indication about the presence of an ETWS notification, upon receiving an indication about the presence of a CMAS notification, upon receiving a notification that the extended access barring (EAB) parameters have changed, upon receiving a request from CDMA2000 upper layers and upon exceeding the maximum validity duration. Unless explicitly stated otherwise in the procedural specification, the system information acquisition procedure overwrites any stored system information, i.e. delta configuration is not applicable for system information and the UE discontinues using a field if it is absent in system information unless explicitly specified otherwise.

The UE shall:

1> ensure having a valid version, as defined below, of (at least) the following system information, also referred to as the ‘required’ system information:

2> if in RRC_IDLE:

3> the MasterInformationBlock (step S60) and SystemInformationBlockType1 (step S61) as well as SystemInformationBlockType2 through SystemInformationBlockType8, depending on support of the concerned RATs;

2> if in RRC_CONNECTED:

3> the MasterInformationBlock (step S60), SystemInformationBlockType1 (step S61) and SystemInformationBlockType2 as well as SystemInformationBlockType8, depending on support of CDMA2000;

1> delete any stored system information after 3 hours from the moment it was confirmed to be valid, unless specified otherwise;

1> consider any stored system information except SystemInformationBlockType10, SystemInformationBlockType11, systemInformationBlockType12 and systemInformationBlockType14 to be invalid if systeminfoValueTag included in the SystemInformationBlockType1 is different from the one of the stored system information;

The UE shall:

1> apply the specified BCCH configuration;

1> if the procedure is triggered by a system information change notification:

2> start acquiring the required system information from the beginning of the modification period following the one in which the change notification was received.

The UE continues using the previously received system information until the new system information has been acquired.

1> if the UE is in RRC_IDLE and enters a cell for which the UE does not have stored a valid version of the system information required in RRC_IDLE:

2> acquire, using the system information acquisition procedure, the system information required in RRC_IDLE;

1> following successful handover completion to a primary cell (PCell) for which the UE does not have stored a valid version of the system information required in RRC_CONNECTED:

2> acquire, using the system information acquisition procedure, the system information required in RRC_CONNECTED;

2> upon acquiring the concerned system information:

3> discard the corresponding radio resource configuration information included in the radioResourceConfigCommon previously received in a dedicated message, if any;

1> following a request from CDMA2000 upper layers:

2> acquire SystemInformationBlockType8;

1> neither initiate the RRC connection establishment procedure nor initiate transmission of the RRCConnectionReestablishmentRequest message until the UE has a valid version of the MasterInformationBlock and SystemInformationBlockType1 messages as well as SystemInformationBlockType2;

1> not initiate the RRC connection establishment subject to EAB until the UE has a valid version of SystemInformationBlockType14, if broadcast;

1> if the UE is ETWS capable:

2> upon entering a cell during RRC_IDLE, following successful handover or upon connection re-establishment:

3> discard any previously buffered warningMessageSegment;

3> clear, if any, the current values of messageIdentifier and serialNumber for SystemInformationBlockType11;

2> when the UE acquires SystemInformationBlockType1 following ETWS indication, upon entering a cell during RRC_IDLE, following successful handover or upon connection re-establishment:

3> if schedulingInfoList indicates that SystemInformationBlockType10 is present:

4> start acquiring SystemInformationBlockType10 immediately;

3> if schedulingInfoList indicates that SystemInformationBlockType11 is present:

4> start acquiring SystemInformationBlockType11 immediately.

UEs shall start acquiring SystemInformationBlockType10 and

SystemInformationBlockType11 as described above even when systeminfoValueTag in SystemInformationBlockType1 has not changed.

1> if the UE is CMAS capable:

2> upon entering a cell during RRC_IDLE, following successful handover or upon connection re-establishment:

3> discard any previously buffered warningMessageSegment;

3> clear, if any, stored values of messageIdentifier and serialNumber for SystemInformationBlockType12 associated with the discarded warningMessageSegment;

2> when the UE acquires SystemInformationBlockType1 following CMAS indication, upon entering a cell during RRC_IDLE, following successful handover and upon connection re-establishment:

3> if schedulingInfoList indicates that SystemInformationBlockType12 is present:

4> acquire SystemInformationBlockType12; UEs shall start acquiring SystemInformationBlockType12 as described above even when systeminfoValueTag in SystemInformationBlockType1 has not changed.

1> if the UE is interested to receive MBMS services:

2> if schedulingInfoList indicates that SystemInformationBlockType13 is present and the UE does not have stored a valid version of this system information block:

3> acquire SystemInformationBlockType13;

2> if the UE is capable of MBMS Service Continuity:

3> if schedulingInfoList indicates that SystemInformationBlockType15 is present and the UE does not have stored a valid version of this system information block:

4> acquire SystemInformationBlockType15;

1> if the UE is EAB capable:

2> when the UE does not have stored a valid version of SystemInformationBlockType14 upon entering RRC_IDLE, or when the UE acquires SystemInformationBlockType1 following EAB parameters change notification or upon entering a cell during RRC_IDLE:

3> if schedulingInfoList indicates that SystemInformationBlockType14 is present:

4> start acquiring SystemInformationBlockType14 immediately;

3> else:

4> discard SystemInformationBlockType14, if previously received;

EAB capable UEs start acquiring SystemInformationBlockType14 as described above even when systeminfoValueTag in SystemInformationBlockType1 has not changed. EAB capable UEs maintain an up to date SystemInformationBlockType14 in RRC_IDLE.

The UE may apply the received SIBs immediately, i.e. the UE does not need to delay using a SIB until all SI messages have been received. The UE may delay applying the received SIBs until completing lower layer procedures associated with a received or a UE originated RRC message, e.g. an ongoing random access procedure. While attempting to acquire a particular SIB, if the UE detects from schedulingInfoList that it is no longer present, the UE should stop trying to acquire the particular SIB.

System information regarding the PWS is described. It may be referred to Section 5.3.2 of 3GPP TS 36.331 V12.0.0 (2013-12).

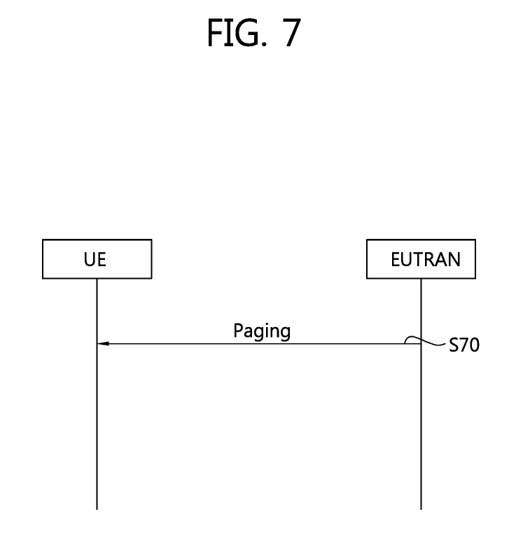

FIG. 7 shows a paging procedure. The purpose of the paging procedure is to transmit paging information to a UE in RRC_IDLE, and/or to inform UEs in RRC_IDLE and UEs in RRC_CONNECTED about a system information change, and/or to inform about an ETWS primary notification and/or ETWS secondary notification, and/or to inform about a CMAS notification. The paging information is provided to upper layers, which in response may initiate RRC connection establishment, e.g. to receive an incoming call.

In step S70, the E-UTRAN initiates the paging procedure by transmitting the Paging message at the UE's paging occasion. The E-UTRAN may address multiple UEs within a Paging message by including one PagingRecord for each UE. The E-UTRAN may also indicate a change of system information, and/or provide an ETWS notification or a CMAS notification in the Paging message.

Upon receiving the Paging message, the UE shall:

1> if in RRC_IDLE, for each of the PagingRecord, if any, included in the Paging message:

2> if the ue-Identity included in the PagingRecord matches one of the UE identities allocated by upper layers:

3> forward the ue-Identity and the en-Domain to the upper layers;

1> if the systeminfoModification is included:

2> re-acquire the required system information using the system information acquisition procedure.

1> if the etws-Indication is included and the UE is ETWS capable:

2> re-acquire SystemInformationBlockType1 immediately, i.e., without waiting until the next system information modification period boundary;

2> if the schedulingInfoList indicates that SystemInformationBlockType10 is present:

3> acquire SystemInformationBlockType10;

2> if the schedulingInfoList indicates that SystemInformationBlockType11 is present:

3> acquire SystemInformationBlockType11;

1> if the cmas-Indication is included and the UE is CMAS capable:

2> re-acquire SystemInformationBlockType1 immediately, i.e., without waiting until the next system information modification period boundary;

2> if the schedulingInfoList indicates that SystemInformationBlockType12 is present:

3> acquire SystemInformationBlockType12;

1> if in RRC_IDLE, the eab-ParamModification is included and the UE is EAB capable:

2> consider previously stored SystemInformationBlockType14 as invalid;

2> re-acquire SystemInformationBlockType1 immediately, i.e., without waiting until the next system information modification period boundary;

2> re-acquire SystemInformationBlockType14 using the system information acquisition procedure;

Table 1 shows an example of the Paging message.

TABLE 1
-- ASN1START

| | |
|---|---|
| Paging ::= | SEQUENCE { |

| | | |
|---|---|---|
| pagingRecordList | PagingRecordList | OPTIONAL, -- Need ON |
| systemInfoModification | ENUMERATED {true} | OPTIONAL, -- Need ON |
| etws-Indication | ENUMERATED {true} | OPTIONAL, -- Need ON |

| | | |
|---|---|---|
| nonCriticalExtension | Paging-v890-IEs | OPTIONAL -- Need OP |

}

| | |
|---|---|
| Paging-v890-IEs ::= | SEQUENCE { |

| | | |
|---|---|---|
| lateNonCriticalExtension | OCTET STRING | OPTIONAL, -- Need OP |
| nonCriticalExtension | Paging-v920-IEs | OPTIONAL -- Need OP |

}
Paging-v920-IEs ::= SEQUENCE {

| | | |
|---|---|---|
| cmas-Indication-r9 | ENUMERATED {true} | OPTIONAL, -- Need ON |
| nonCriticalExtension | Paging-v1130-IEs | OPTIONAL -- Need OP |

}
...
-- ASN1STOP

Referring to Table 1, the cmas-Indication field indicates indication of a CMAS notification, if present. The etws-Indication field indicates indication of an ETWS primary notification and/or ETWS secondary notification.

MBMS is described. It may be referred to Section 15 of 3GPP TS 36.300 V11.7.0 (2013-09) and Section 5.8 of 3GPP TS 36.331 V12.0.0 (2013-12).

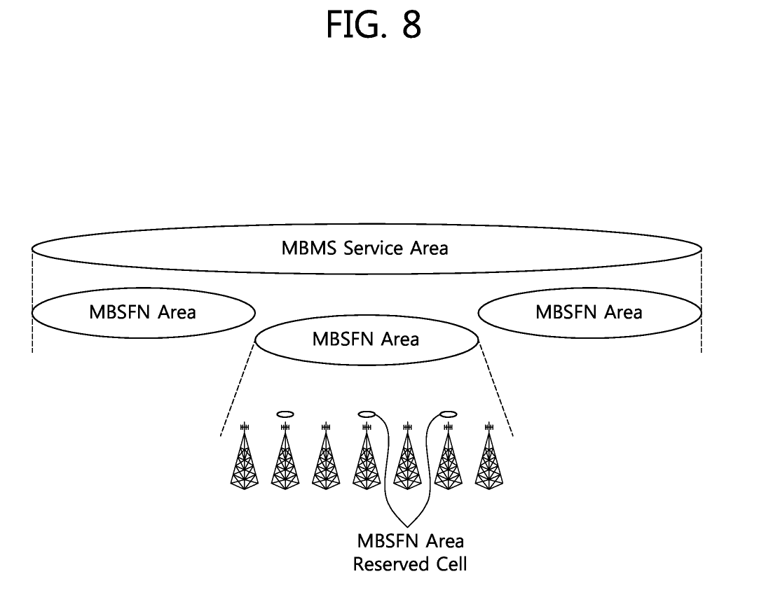

FIG. 8 shows MBMS definitions. For MBMS, the following definitions may be introduced.
Multicast-broadcast single-frequency network (MBSFN) synchronization area: This is an area of the network where all eNBs can be synchronized and perform MBSFN transmissions. MBSFN synchronization areas are capable of supporting one or more MBSFN areas. On a given frequency layer, an eNB can only belong to one MBSFN synchronization area. MBSFN synchronization areas are independent from the definition of MBMS service areas.
MBSFN transmission or a transmission in MBSFN mode: This is a simulcast transmission technique realized by transmission of identical waveforms at the same time from multiple cells. An MBSFN transmission from multiple cells within the MBSFN area is seen as a single transmission by a UE.
MBSFN area: an MBSFN area consists of a group of cells within an MBSFN synchronization area of a network, which are coordinated to achieve an MBSFN transmission. Except for the MBSFN area reserved cells, all cells within an MBSFN area contribute to the MBSFN transmission and advertise its availability. The UE may only need to consider a subset of the MBSFN areas that are configured, i.e., when it knows which MBSFN area applies for the service(s) it is interested to receive.
MBSFN area reserved cell: This is a cell within a MBSFN area which does not contribute to the MBSFN transmission. The cell may be allowed to transmit for other services but at restricted power on the resource allocated for the MBSFN transmission.
Synchronization sequence: Each synchronization protocol data unit (SYNC PDU) contains a time stamp which indicates the start time of the synchronization sequence. For an MBMS service, each synchronization sequence has the same duration which is configured in the broadcast and multicast service center (BM-SC) and the multi-cell/multicast coordination entity (MCE).
Synchronization period: The synchronization period provides the time reference for the indication of the start time of each synchronization sequence. The time stamp which is provided in each SYNC PDU is a relative value which refers to the start time of the synchronization period. The duration of the synchronization period is configurable.

In general, the control information relevant only for UEs supporting MBMS is separated as much as possible from unicast control information. Most of the MBMS control information is provided on a logical channel specific for MBMS common control information: the MCCH. E-UTRA employs one MCCH logical channel per MBSFN area. In case the network configures multiple MBSFN areas, the UE acquires the MBMS control information from the MCCHs that are configured to identify if services it is interested to receive are ongoing. An MBMS capable UE may be only required to support reception of a single MBMS service at a time. The MCCH carries the MBSFNAreaConfiguration message, which indicates the MBMS sessions that are ongoing as well as the (corresponding) radio resource configuration. The MCCH may also carry the MBMSCountingRequest message, when E-UTRAN wishes to count the number of UEs in RRC_CONNECTED that are receiving or interested to receive one or more specific MBMS services.

A limited amount of MBMS control information is provided on the BCCH. This primarily concerns the information needed to acquire the MCCH(s). This information is carried by means of a single MBMS specific SystemInformationBlock: SystemInformationBlockType13. An MBSFN area is identified solely by the mbsfn-AreaId in SystemInformationBlockType13. At mobility, the UE considers that the MBSFN area is continuous when the source cell and the target cell broadcast the same value in the mbsfn-AreaId.

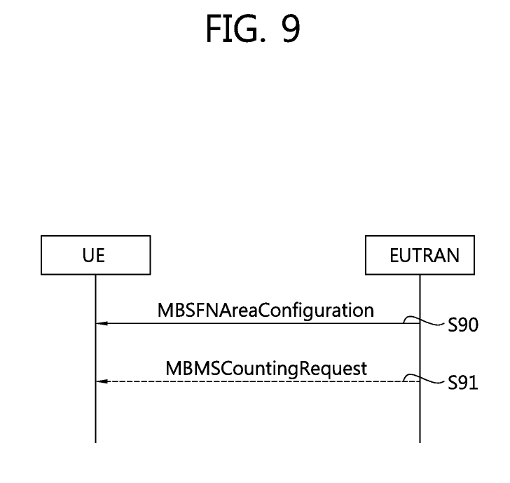

FIG. 9 shows a MCCH information acquisition procedure. The UE applies the MCCH information acquisition procedure to acquire the MBMS control information that is broadcasted by the E-UTRAN. The procedure applies to MBMS capable UEs that are in RRC_IDLE or in RRC_CONNECTED.

A UE interested to receive MBMS services shall apply the MCCH information acquisition procedure upon entering the corresponding MBSFN area (e.g. upon power on, following UE mobility) and upon receiving a notification that the MCCH information has changed. A UE that is receiving an MBMS service shall apply the MCCH information acquisition procedure to acquire the MCCH, which corresponds with the service that is being received, at the start of each modification period.

Unless explicitly stated otherwise in the procedural specification, the MCCH information acquisition procedure overwrites any stored MCCH information, i.e. delta configuration is not applicable for MCCH information and the UE discontinues using a field if it is absent in MCCH information unless explicitly specified otherwise.

An MBMS capable UE shall:

1> if the procedure is triggered by an MCCH information change notification:

2> start acquiring the MBSFNAreaConfiguration message (in step S90) and the MBMSCountingRequest message if present (in step S91), from the beginning of the modification period following the one in which the change notification was received;

1> if the UE enters an MBSFN area:

2> acquire the MBSFNAreaConfiguration message (in step S90) and the MBMSCountingRequest message if present (in step S91), at the next repetition period;

1> if the UE is receiving an MBMS service:

2> start acquiring the MBSFNAreaConfiguration message (in step S90) and the MBMSCountingRequest message if present (in step S91), that both concern the MBSFN area of the service that is being received, from the beginning of each modification period;

Multimedia broadcast supplement (MBS) for the PWS may be provided, in addition to the PWS message. The MBS may be provided via MBMS and/or evolved MBMS (eMBMS). The UE is required to receive the PWS message via system information before receiving MBMS for the PWS via MBMS or eMBMS. In this case, the UE may receive system information and then start to monitor MCCH and MTCH. Thereafter, the UE can receive MBMS via MBMS and/or eMBMS. Such a reception process may consume some time relative to the reception of the PWS message, and so MBS, which has to be provided urgently, cannot be reached to the UE quickly.

In order to solve the problem described above, a method for transmitting MBS for PWS according to an embodiment of the present invention is described below. According to an embodiment of the present invention, the eNB transmits MBS information which indicates whether the cell supports MBS via system information, and transmits an MBS indication for the PWS message.

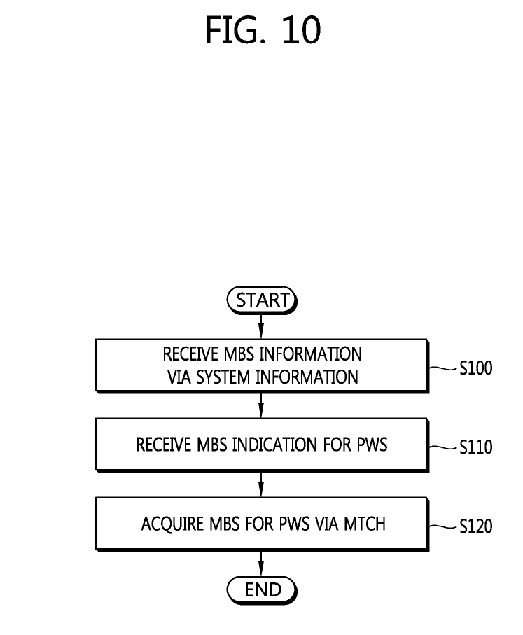

FIG. 10 shows an example of a method for transmitting MBS for PWS according to an embodiment of the present invention. It is assumed that the UE may be in RRC_IDLE or in RRC_CONNECTED, and may support ETWS/CMAS and MBMS.

In step S100, the UE receives MBS information from the network. The MBS information may be received via system information. The MBS information may indicate at least one of whether the cell supports the MBS for the PWS, the service area identifier (SAI) corresponding to the MBMS service area where the MBS is to be transmitted, the MBSFN area where the MBS is to be transmitted, or the MBMS related channel, such as physical multicast channel (PMCH)/MCCH/MTCH, corresponding to the MBS.

In step S110, the UE receives the MBS indication for the PWS from the network. The MBS indication may be received via the paging message, SIB1 or PDCCH indicating a paging radio network temporary identity (P-RNTI). If the MBS indication is received via the paging message, the paging message should include either the ETWS indication or CMAS indication. That is, if the MBS indication is present in the paging message, either the ETWS indication or the CMAS indication should be present in the same paging message. If either the ETWS indication or the CMAS indication is not present in the paging message, but the MBS indication is present in the paging message, the UE may ignore the MBS indication in the paging message.

Upon receiving the MBS indication, the UE may start monitoring/receiving a MBMS-related channel, such as MCCH or MTCH, while receiving the SIB carrying the PWS message (i.e. receiving SIB10, SIB11 or SIB12 upon receiving the ETWS/CMAS indication). The MCCH may be received only if system information at the cell, where the UE is camped on, includes the SAI corresponding to the MBMS service area where the MBS is to be transmitted. Further, the UE may acquire the configuration for the MBS via the MCCH. The configuration may include information on the MBS. The information on the MBS may include the temporary mobile group identity (TMGI) dedicated to the MBS, and the configuration of PMCH carrying the MTCH where the MBS is transmitted. The UE may already know which TMGI corresponds to the MBS (or which SAI/MBSFN area/PMCH/MCCH/MTCH corresponds to the MBS). Alternatively, the MTCH used to carry the MBS may be pre-configured, i.e. the MTCH corresponds to the pre-configured MBMS radio bearer (MRB). Thus, the UE may already know the configuration without acquiring the configuration via the MCCH.

In step S120, the UE acquires the MBS for the PWS via the broadcast/multicast channel, such as MTCH, from the network. The MBS may be acquired only if system information at a cell, where the UE is camped on, includes the SAI corresponding to the MBMS service area where the MBS is to be transmitted. Alternatively, the MBS may be acquired upon receiving the MBS indication. The MBS provides additional multimedia public warning information to a user, in addition to the PWS message.

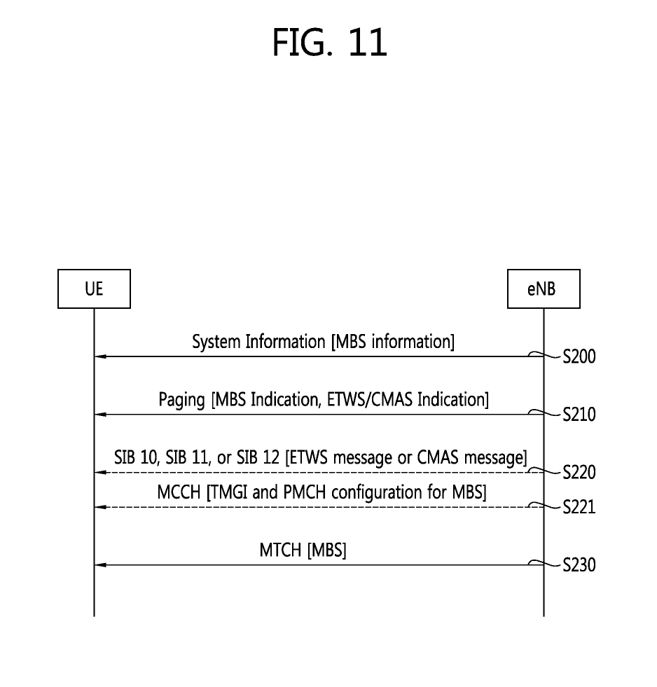

FIG. 11 shows another example of a method for transmitting MBS for PWS according to an embodiment of the present invention.

In step S200, the UE receives MBS information via system information. The MBS information may indicate whether the cell supports the MBS, the SAI corresponding to the MBMS area where the MBS will be transmitted, the MBSFN area where the MBS will be transmitted, and the PMCH/MCCH/MTCH corresponding to the MBS.

In step S210, the UE monitors paging message. The UE may acquire the MBS indication from the paging message. Alternatively, the UE may acquire the MBS indication from either PDCCH carrying P-RNTI or SIB1. The paging message may further include the ETWS indication or CMAS indication, which relates to the MBS indication. Thus, if the MBS indication is acquired via the paging message, either the ETWS indication or CMAS indication should be included in the same paging message. If the paging message includes the MBS indication but does not include either the ETWS indication or CMAS indication, the UE may ignore the MBS indication in the paging message, i.e. the UE may consider the MBS indication as an invalid MBS indication.

Upon receiving the (valid) MBS indication, in step S220, the UE may receive the PWS message, such as a primary/secondary ETWS message or a CMAS message, via SIB10, SIB11 or SIB12. Further, in step S221, the UE may start monitoring the MBMS-related channel, such as MCCH or MTCH. The UE may monitor/receive the MCCH corresponding to the MBSFN area and the MBMS service area where the MBS will be transmitted. The UE may receive the MCCH, only if the system information at a cell where the UE is camped on broadcasts the SAI corresponding to the MBMS service area where the MBS will be transmitted.

The network may inform the UE of TMGI/SAI/MBSFN area corresponding to the MBS via RRC/NAS/application message. The UE may know which TMGI/SAI/MBSFN area corresponds to the MBS, e.g. by receiving the RRC/NAS/application message. The RRC message may be the paging message or system information block. The UE may acquire a RRC message including a configuration via the MCCH. The configuration may include information on the MBS. The information on the MBS may include TMGI dedicated to the MBS, configuration of PMCH carrying the MTCH where the MBS is transmitted. The RRC message on the MCCH may be dedicated to the MBS. In case of the MBS, the specific RRC message (and the specific MCCH) which provides the MBS may not follow MCCH modification period for update of the RRC message on the MCCH. Thus, the network may change the specific RRC message in the middle of the MCCH modification period, if the RRC message is used to provide the MBS.

In step S20, the UE acquires the MBS via the MTCH based on the received configuration. The UE may receive the MTCH, only if the system information at a cell where the UE is camped on broadcasts the SAI corresponding to the MBMS service area where the MBS will be transmitted. Alternatively, the UE may know which MTCH carries the MBS by a RRC/NAS/application message in case that the MTCH is pre-configured for the MBS. Hence, the UE may directly start receiving the MTCH upon receiving the MBS indication, without receiving the configuration via the MCCH, in order to acquire the MBS.

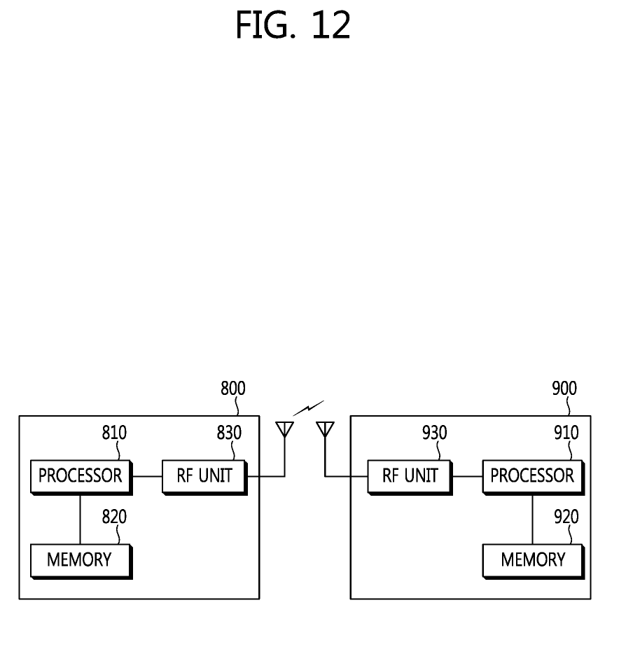

FIG. 12 shows a wireless communication system to implement an embodiment of the present invention.

An eNB 800 may include a processor 810, a memory 820 and a radio frequency (RF) unit 830. The processor 810 may be configured to implement proposed functions, procedures and/or methods described in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

A UE 900 may include a processor 910, a memory 920 and a RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What is claimed is:

1. A method for acquiring, by a user equipment (UE), multimedia broadcast supplement (MBS) for a public warning system (PWS) in a wireless communication system, the method comprising:
receiving, by the UE, MBS information from a network;
receiving, by the UE, a MBS indication for the PWS from the network; and
acquiring, by the UE, the MBS for the PWS via a broadcast/multicast channel from the network.

2. The method of claim 1, wherein the MBS information is received via system information.

3. The method of claim 1, wherein the MBS information indicates at least one of whether a cell supports the MBS for the PWS, a service area identifier (SAI) corresponding to a multimedia broadcast multicast service (MBMS) service area where the MBS is to be transmitted, a multicast broadcast single frequency network (MBSFN) area where the MBS is to be transmitted, or a MBMS related channel corresponding to the MBS.

4. The method of claim 1, wherein the MBS indication is received via a paging message, a system information block type 1 (SIB1) or a physical downlink control channel (PDCCH) indicating a paging radio network temporary identity (P-RNTI).

5. The method of claim 4, wherein if the MBS indication is received via the paging message, the paging message includes either an earth and tsunami warning system (ETWS) indication or a commercial mobile alert system (CMAS) indication.

6. The method of claim 1, wherein the broadcast/multicast channel is a multicast traffic channel (MTCH).

7. The method of claim 1, wherein the MBS is acquired only if system information at a cell, where the UE is camped on, includes a SAI corresponding to a MBMS service area where the MBS is to be transmitted.

8. The method of claim 1, wherein the MBS is acquired upon receiving the MBS indication.

9. The method of claim 1, further comprising receiving system information including a PWS message, upon receiving the MBS indication.

10. The method of claim 9, wherein the system information corresponds to SIB10, SIB11, or SIB12.

11. The method of claim 1, further comprising receiving a multicast control channel (MCCH), upon receiving the MBS indication.

12. The method of claim 11, wherein the MCCH is received only if system information at a cell, where the UE is camped on, includes a SAI corresponding to a MBMS service area where the MBS is to be transmitted.

13. The method of claim 11, further comprising acquiring a configuration for the MBS via the MCCH from the network.

14. The method of claim 13, wherein the configuration for the MBS includes a temporary mobile group identity (TMGI) dedicated to the MBS and a configuration of a physical multicast channel PMBCH) carrying a MTCH where the MBS is to be transmitted.

15. A user equipment (UE) configured to acquire multimedia broadcast supplement (MBS) for a public warning system (PWS) in a wireless communication system, the UE comprising:
a radio frequency (RF) unit configured to transmit or receive a radio signal; and
a processor coupled to the RF unit, and configured to:
receive MBS information from a network;
receive a MBS indication for the PWS from the network; and
acquire the MBS for the PWS via a broadcast/multicast channel from the network.
